(19) United States
(12) Patent Application Publication
(10) Pub. No.: US 2025/0225408 A1
(43) Pub. Date: Jul. 10, 2025

(54) Smart Simplex Splitting Optimizer

(71) Applicant: NXP USA, Inc., Austin, TX (US)

(72) Inventors: Sepehr Bijani, Munich (DE); Stefan Schwarz, Siegertsbrunn (DE); Michael Andreas Staudenmaier, Munich (DE)

(73) Assignee: NXP USA, Inc., Austin, TX (US)

(21) Appl. No.: 18/407,882

(22) Filed: Jan. 9, 2024

(51) Int. Cl. G06N 5/01

(52) U.S. Cl. CPC G06N 5/01

(57) ABSTRACT

An artificial intelligence-based optimization method, system, and apparatus are provided for solving non-convex, high dimension optimization problems and tuning complex, multi-parameter systems by converting the default Cartesian search space into a simplex search space to improve search efficiency, evaluating search sampling points for making next-search point decisions by applying a surrogate gradient boost tree function which learns from objective-function query results from historical search samples, and then applying a next search-point determining strategy.

### BACKGROUND

### Field

This disclosure is directed in general to the field of optimizing system parameters of complex systems. In one aspect, the disclosure relates to systems and methods using simplex space and machine learning algorithms for optimizing operating parameters of non-convex systems.

### Description of the Related Art

Tuning or optimizing system parameters involves finding the combination of system parameters that achieves the optimal performance for the system. For example, hyperparameter optimization (HPO) is a common problem with machine learning algorithms, such as logistic regression and neural nets, which depend on well-tuned hyperparameters to reach maximum effectiveness. However, hyperparameter optimization is not only computationally intensive, but also must take into account that different constraints, weights or learning rates may apply for different parameters. For example, the parameters for a PID controller that is being tuned may include an integrator gain value (I) that has a limited range of allowable values so that the tuned (I) value should not lie outside of the predefined limitation. In general, a tuning task can be defined as an optimization problem with another constraint. In a tuning task, it is costly to call Objective function. Therefore, a good tuner will not call objective function too many times. There is no global method for tuning process of a general system since the optimization problem could be non-convex. As a result, the general tuning will not be solvable by conventional methods.

In order to optimize a set of hyperparameters, the optimization process seeks to find a tuple of hyperparameters that minimizes a predefined loss function, such as an objective key performance indicator (KPI), for a system model. To date, several approaches have been proposed for optimizing system parameters, including using a Grid Search (to exhaustively searching through a manually specified subset of the parameter space of a learning algorithm), a Random Search (to randomly selects combinations of parameters), Bayesian Optimization (to build a probabilistic model of the function mapping from parameter values to the objective evaluated on a validation set), Gradient-Based Optimization (to compute the gradient with respect to hyperparameters and then optimize the hyperparameters using gradient descent), and Genetic Optimization (to use selection rules, crossover rules, and mutation rules to create the next generation from the current population). However, existing solutions for optimizing system parameters suffer from a range of limitations and difficulties. For example, Bayesian search optimization methods have used a Gaussian process (GP) surrogate model for tuning hyperparameters in neural network, but most real systems do not have Gaussian behavior. In addition, Bayesian optimization techniques which use GP surrogate models are effective when the number of parameters is small, but this tuning approach is limited to low degree of freedom systems since having a Gaussian model with more than 10 parameters will slow down the tuning process because of the significant computational resources required to solve such models. Another challenge with existing optimization solutions is that they are limited to linear or convex systems, and there are no existing tuning solutions available for tuning a non-convex system.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a simplified diagram illustration of a gradient boosting decision tree methodology and model for supervised machine learning which may be used in connection with selected embodiments of the present disclosure.

FIG. 2 is a simplified illustration showing an N-dimensional simplex space being split into simplex subspaces around a conventional center point and a candidate point that is selected in accordance with selected embodiments of the present disclosure.

FIG. 3 depicts a simplified flow chart showing the processing steps for increasing the complexity of the gradient boosting decision tree model so that the number of iterations used in a gradient boost decision tree ensures that the model error complies with an error threshold requirement in accordance with selected embodiments of the present disclosure.

FIG. 4 depicts a simplified flow chart showing the processing steps for a smart simplex splitting method which uses AI-based optimization for solving non-convex optimization problems and tuning complex systems in accordance with selected embodiments of the present disclosure.

FIG. 5 is a simplified illustration showing an N-dimensional simplex space wherein a plurality of optima paths leading to different optima values are computed in accordance with selected embodiments of the present disclosure.

FIG. 6 depicts a simplified schematic block diagram of a computer system in accordance with selected embodiments of the present disclosure.

### DETAILED DESCRIPTION

A computer-based method, system, architecture, apparatus, and program code are described for optimizing multiple parameters of a non-convex system having a high degree of freedom (e.g., 10 or more parameters) by using a gradient boosting surrogate model for selecting the best simplex subspace to split and for selecting which candidate point inside the selected simplex subspace to evaluate next. In selected embodiments, the generation of candidate points inside the simplex subspaces is randomized by using Dirichlet Sampling and Linear Mapping (DSLM) to generate spatially independent candidates inside a simplex search space, thereby guaranteeing good exploration of the simplex space. In addition, successive iterations of optimization path searches may use successive prime numbers to determine the number of candidates per simplex, thereby preventing optimization path collisions and suboptimal solutions. By using successive iterations of optimization path searches to train the gradient boosting surrogate model, the model effectively learns from previous failures to correct the optimization path, thereby reducing the parameter optimization or tuning task to a sequence of learning/inference steps that can be used to solve a general or non-convex optimization problem.

By way of background to the present disclosure, parameter optimization solutions have used black box optimization approaches for dealing with systems having an objective function that does not have an explicit mathematical expression. In such cases, it is very costly to obtain a new function evaluation and the emphasis in performance assessment is on minimizing the number of function evaluations in the search for the global optimum. One black box optimization approach is to partition a space into subspaces, assess each subspace, and confine the local search within the boundaries of these partitions. In order to select promising subspaces to re-partition and intensify the search, partitioning methods may rely on a priori knowledge about the rate of change of the function, on Bayesian methods, or on random search techniques providing evidence for fuzzy assessment of partitions. In operation, the optimization process zooms into subspaces where the global optimum might be located by taking as few samples as possible.

One approach for partitioning the search space is to define a hypercube which refers to a box-shaped multi-dimensional space. During optimization, the hypercube is split into smaller sections to perform more effective searching. However, conventional approaches for splitting a hypercube space result in exponential subspaces growing with respect to the problem dimension. For instance, if a problem has 16 parameters, each splitting around a candidate point results in 216=65,536 subspaces, and after 4 iterations will be 264 subspaces. As a result, hypercube splitting is not scalable or practical for computer implementation. One solution to this challenge is to use simplex splitting wherein an N dimensional simplex space is split around a candidate point, resulting in N+1 subspaces. This simplex splitting approach results in a linear growth rate with respect to number of dimensions, thereby avoiding the exponential growth rate of hypercube splitting.

The process for splitting the search space requires the identification and evaluation of candidate simplex split points. An example approach for finding the points inside a hypercube is to use Latin hypercube sampling (LHS) to perform multidimensional sampling on an N dimensional hypercube space defined by N ranges. When sampling M samples from the N-dimension space, the LHS method splits each range into M smaller ranges, takes out one range from the M ranges for each dimension, and then takes a random value from inside the selected ranges to create an N-dimensional vector. The LHS method guarantees independent samples, and has been used extensively for experimental design. Another sampling approach for sampling inside unit simplex is to use Dirichlet sampling which provides N+1 coordinates λᵢ which defines a point inside a flat unit simplex. As result, it will satisfy the requirement Σλᵢ=1. Dirichlet method is only usable when simplex subspaces are flat unit simplexes. As explained more fully hereinbelow and understood by those skilled in the art, there are a number of performance limitations and drawbacks with existing partitioning methods, including the requirement of working with simplex-feasible datasets, surrogate model bias which prevents convergence of the simple(x) algorithm, and getting stuck with local minima results. These disadvantages from conventional approaches and others known to those skilled in the art are addressed with the disclosed smart simplex splitting approach which acquires a set of random, spatially independent points using a Dirichlet Sampling and Linear Mapping (DSLM) algorithm that is designed for sampling from arbitrary subspace simplexes, thereby preventing model immature bias. In addition, the disclosed smart simplex splitting approach uses an Extreme Gradient Boosting (XGBoost) surrogate model to find estimated cost function for all the points for use in selecting a candidate for representing point in each simplex will be the point with the best predicted value. As a result, the XGBoost surrogate model learns the pure data structure of the cost function, thereby avoiding the risk of bias that arises when selecting the middle points of simplex spaces as the simplex splitting point, and also avoiding the risk of failing to identify optima points that are not in the middle of large simplexes.

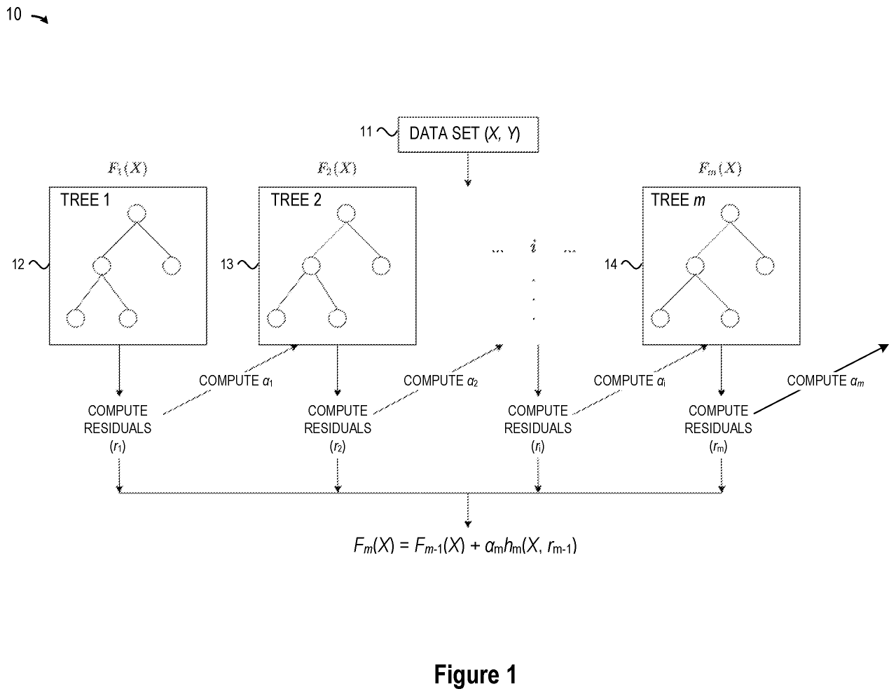

To provide additional details for an improved understanding of selected embodiments of the present disclosure, reference is now made to FIG. 1 which depicts a simplified diagram illustration of a gradient boosting decision tree 10 for use with supervised machine learning methods and models to accurately predict a target variable by combining the estimates of a set of simpler, weaker prediction models, i.e., models that make very few assumptions about the data, which are typically simple decision trees 12-14 Tree 1, Tree 2, . . . . Tree m. In particular, a plurality of “m” decision trees 12-14 are each created as an “XGBoost Iteration,” where each tree maps an input data set points (X, Y) to one of its leaves that contains a continuous score. At each stage m (1≤m≤M) of gradient boosting, an imperfect model Fₘ uses a simple decision tree (e.g., Tree 1 12) to find thresholds for the features in the data set and split the data around the threshold in different layers of tree. For inference, the leaves of all trees will be aggregated with a sum function to predict the dataset output values. Each subsequent tree (e.g., Tree i) will try to predict the error of previous trees by computing a residuals value (e.g., rᵢ). In order to improve the imperfect model Fₘ, each stage Fₘ₊₁ attempts to correct the errors of its predecessor Fₘ by adding a new estimator term, αₘhₘ so that Fₘ(X)=Fₘ₋₁(X)+αₘhₘ(X, rₘ₋₁), where αₘ is a regularization parameter computed with the m^{th} tree, and where hₘ is an estimator function that is trained to predict the residual value rₘ using X for the m^{th} tree. To compute αₘ, the residual value from the previous tree (rₘ₋₁) is used to find the value of α which minimizes the differentiable loss function L(Y, F(X)) by computing:

$${arg}_{α}^{min} {\sum }_{i = 1}^{m} L ( {Y}_{i} , {F}_{i - 1} ( {X}_{i} ) + α {h}_{i} ( {X}_{i} , {r}_{i - 1} ) ) .$$

As a result, the XGBoost algorithm minimizes a regularized objective function L that combines a convex loss function (based on the difference between the predicted and target outputs) and a penalty term for model complexity (in other words, the regression tree functions). The training proceeds iteratively, adding new trees that predict the residuals or errors of prior trees that are then combined with previous trees to make the final prediction. As will be appreciated, the “gradient boosting” name arises because target outcomes for each case are set based on the gradient of the error with respect to the prediction. Each new model takes a step in the direction that minimizes prediction error, in the space of possible predictions for each training case.

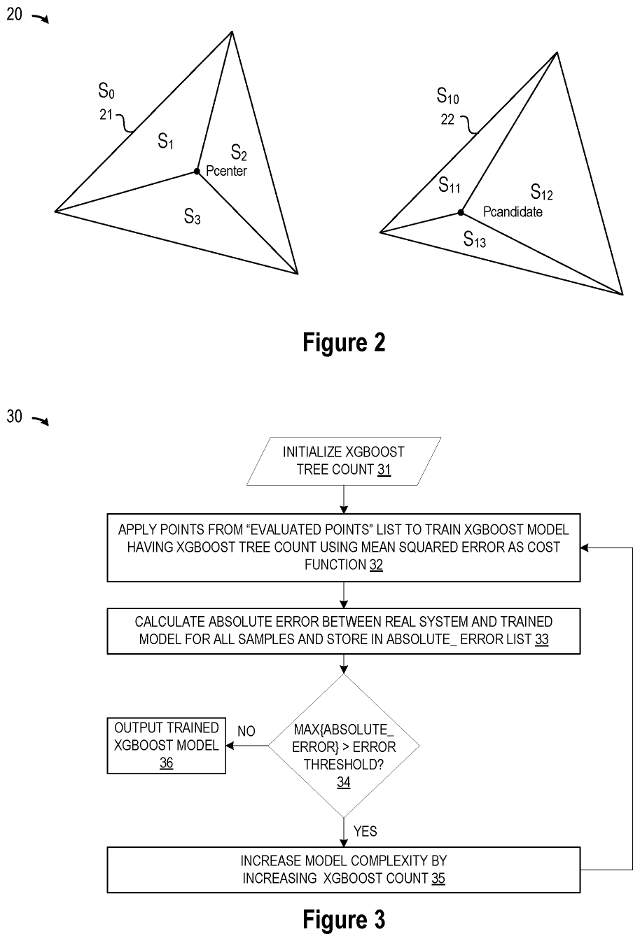

To provide additional details for an improved understanding of selected embodiments of the present disclosure, reference is now made to FIG. 2 which depicts a simplified illustration showing an N-dimensional simplex space S₀ 21 being split into simplex subspaces S₁, S₂, S₃ around a conventionally selected center sample point Pcenter that is located at the center of the simplex space S₀ 21. In this example of a conventional approach for simplex splitting, the N=2 dimensional simplex space S₀ 21 is divided into N+1 simplex subspaces by unintelligently using geometric center sample point Pcenter to generate the simple subspaces S₁, S₂, S₃.

In addition, FIG. 2 depicts an N-dimensional simplex space S₁₀ 22 which is split into simplex sub-spaces S₁₁, S₁₂, S₁₃ around a candidate sample point Pcandidate that is selected by learning from objective function query results from historical search samples. In this example of smart simplex splitting, the N=2 dimensional simplex space S₁₀ 22 is divided into N+1 simplex subspaces S₁₁, S₁₂, S₁₃ by using Dirichlet Sampling and Linear Mapping (DSLM) to identify sample points inside the simplex space S₁₀ 22, and then using the XGBoost surrogate model to estimate the cost function for all sample points to select the candidate sample point Pcandidate as the splitting point with the best predicted value.

In accordance with selected embodiments of the present disclosure, other sampling methods may be used to identify candidate sampling points in a simplex space. For example, Latin Simplex Sampling (LSS) is a derivation of the Latin Hypercube Sampling (LHS) technique which provides a multidimensional sampling method for sampling evenly from an N-dimensional simplex wherein a feasible N-dimensional hypercube space is defined by N ranges, and M samples are identified from the N-dimensional hypercube space by splitting each range to M smaller ranges. In the LSS technique, QS spatially separated (dimensionally independent) samples from a simplex are identified by first taking Q+1 samples from unit N dimensional hyper cube. Then, for each sample qⱼ=(qj⁰ . . . , qjⁿ), the following formula is used:

$$s = {qj}^{0} + … + {qj}^{n} , m = max ( {qj}^{0} , … , {qj}^{n} ) .$$

Then, each sample point qⱼ is mapped to a point inside the simplex by computing:

$$mqj = ( {qj}^{0} \cdot m s , … , {qj}^{n} \cdot ms ) .$$

This maps the unit cube into the simplex qⱼ′≥0, Σqⱼ′≤1.

The set of all mapped random points will be defined as mQ:

$$m Q = [ \begin{matrix}mq 0 \\ ⋮ \\ mqj\end{matrix} ]$$

In order to find points inside the simplex, a simple weighted average of corners of simplex is used, and each column of the matrix mQ is a weighted vector to find a single point inside the simplex.

As disclosed herein, an XGBoost model may be used for predicting cost function behavior relative to the tuning parameters so that the best candidate simplex splitting point is selected. However, the XGBoost model, like any training method, can occasionally fail, resulting in failure of the optimization algorithm. In addition and as described hereinbelow, the number of XGBoost iterations or trees can change during the course of solving the optimization problem. To address these concerns, the XGBoost model may be wrapped with a MinMax method to ensure that the XGBoost model error for all of the points inside the “evaluated points” list will be less than a specified maximum error threshold. In selected embodiments, the MinMax method runs as a loop to continuously or periodically test the trained XGBoost model by finding its maximum error for all samples in the dataset, and if the XGBoost model is not accurate enough, the complexity of XGBoost model will be increased by adding a new tree until the maximum error of XGBoost model is minimized or reduced below the specified maximum error threshold.

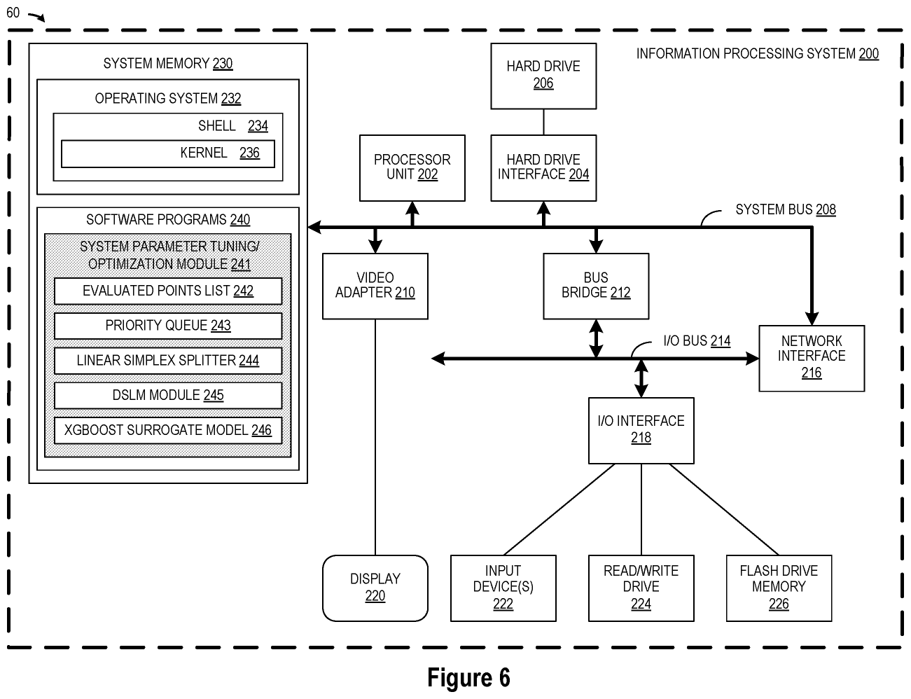

To provide additional details for an improved understanding of selected embodiments of the present disclosure, reference is now made to FIG. 3 which depicts a simplified flow chart 30 showing the processing steps 31-36 for wrapping the XGBoost model with a MinMax method. In operation, the method increases the complexity of the gradient boosting decision tree model so that the number of iterations used in a gradient boost decision tree ensures that the model error complies with an error threshold requirement. The processing steps can be implemented, for example, by the processor unit 202 of FIG. 6. The processing steps are merely representative groupings of functionality, as there can be more or fewer steps, and the steps can be performed in different orders. Many other variations of the processing steps are possible.

At step 31, an initial XGBoost tree count value is specified. For example, the XGBoost tree count value may be initialized so that the XGBoost decision tree has 4 trees.

At step 32, all points from an “evaluated points” list are applied to train the XGBoost model having the XGBoost tree count using a means squared error as the cost function. As used herein, each “evaluated point” refers to the input parameter set and corresponding key performance indicator (KPI) output value from the real system.

At step 33, the absolute error values between the real system and the trained model are calculated for all sample points and stored an “absolute error” list. For each evaluated point, the “absolute error” refers to the difference between the KPI output value from the real system and a KPI output value from the trained model.

At step 34, the model error for all of the points inside the “evaluated points” list is compared to a specified maximum error threshold. For example, if the maximum absolute error value from the “absolute error” list is less than or equal to the specified maximum error threshold (negative outcome to comparison step 34), then the XGBoost model is sufficiently accurate, and the trained XGBoost model is output or returned at step 36. However, if the maximum absolute error value from the “absolute error” list is greater than the specified maximum error threshold (affirmative outcome to comparison step 34), then the model complexity of the XGBoost model is increased by increasing the XGBoost count at step 35, thereby increasing the number of XGBoost trees before returning to step 32 to repeat the processing steps 32-35 until the trained XGBoost model is sufficiently accurate or adequately trained. As will be appreciated, the number of trees can be increased using any suitable technique, including but not limited to incrementing the current tree count by a set value (e.g., 1) or by multiplying the current tree count by a set value (e.g., x2).

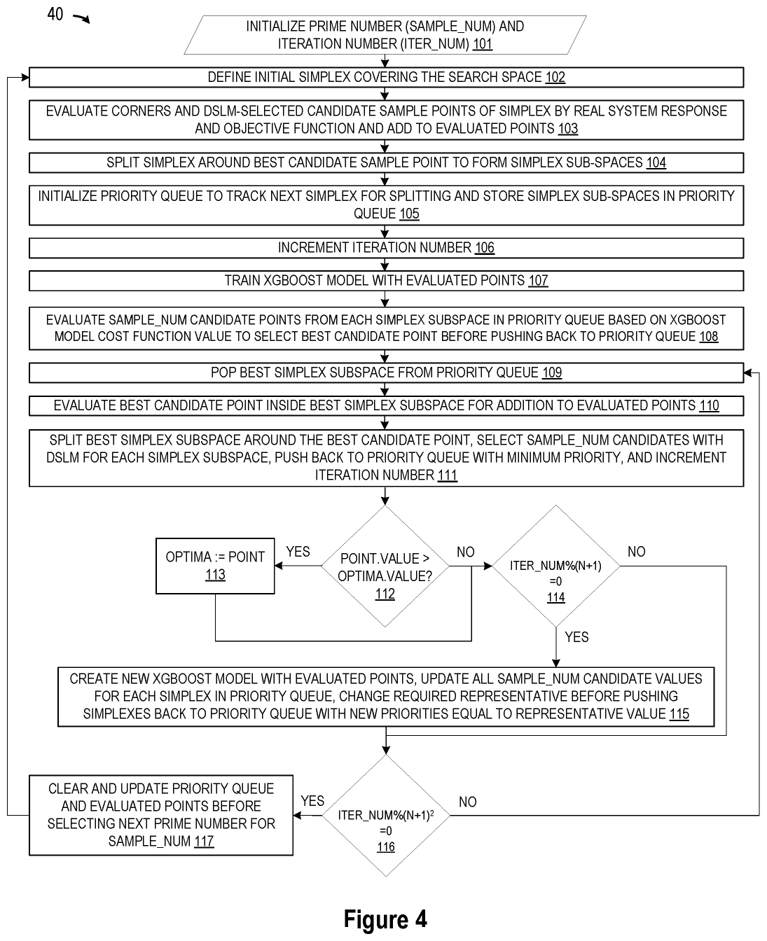

To provide additional details for an improved understanding of selected embodiments of the present disclosure, reference is now made to FIG. 4 which depicts a simplified flow chart showing 40 the processing steps 101-115 for a smart simplex splitting method which uses AI-based optimization for solving non-convex optimization problems and tuning complex systems. The disclosed method provides a fast, efficient accurate and robust approach for tuning parameters of a high-dimensional optimization problem, such as searching for the best neural net architecture parameters (10's parameters) or tuning a picture for white balancing (8 parameters). The processing steps can be implemented, for example, by the processor unit 202 of FIG. 6. The processing steps are merely representative groupings of functionality, as there can be more or fewer steps, and the steps can be performed in different orders. Many other variations of the processing steps are possible.

In connection with the smart simplex splitting approach described herein, the proposed algorithm provides a learning or inference-based method for solving a general (non-convex) optimization problem by constructing an optimization path of evaluated points in a parameter space with processing iterations which search the parameter space using an objective function to evaluate search sampling points for making next search-point decisions. In this context, an evaluated point refers to a parameter set of one or more values (or coordinates) that are input to a real system and corresponding key performance indicator (KPI) value that is output from real system (e.g., Point={coordinates, KPI value}). In addition, an optimization path refers to a set of one or more evaluated points extending from an initial point to a final optima. In addition, an iteration refers to the processing steps used to construct the optimization path. As will be appreciated, any Minimization optimization problem can be redefined as Maximization problem by negating the cost function, so the KPI value can be negated for a minimization problem for unifying both cases. As a result, a larger KPI value will result in a better point for both maximization and minimization problems.

Generally speaking, the algorithmic structure of the simplex splitting approach described herein includes a “priority queue” component that tracks which simplex should be split next. In addition, an “evaluated points” list component tracks all evaluated points for each optimization path which may be used for training the model when needed In addition, an “optima point” component keeps track of the best found point identified so far with the iterative computing process.

At step 101, a system initialization step is performed to set an initial prime number value (Sample_Num) and an iteration number (Iter_Num). The prime number value determines how many samples inside the simplex subspaces will be created over the following iterations of processing steps which is set by the iteration number. For example, the prime number value may be initialized to Sample_Num:=2, and the iteration number may be initialized to Iter_Num:=0.

At step 102, an initial simplex covering the search space is defined (N dimensional unit simplex). In this step, the default Cartesian search space is converted into a simplex one to improve the search efficiency. This step is used to (re) start each outer loop optima computation path, and may be implemented by retrieving the initial simplex from memory.

At step 103, the corners of the initial simplex and Sample_Num samples inside the initial simplex will be evaluated by using the real system response and an objective function, with the evaluation results being added to the evaluated points list. To account for non-flat arbitrary simplexes, sampling is done with a Dirichlet Sampling and Linear Mapping (DSLM) method to guarantee maximum coverage of space. Under the DSLM method, a point inside a non-flat unit simplex in N dimension should satisfy Σyᵢ<1. In particular, point sampling inside a non-flat arbitrary N-dimensional simplex can be done by first sampling a point inside the N+1 dimensional unit simplex using the Dirichlet sampling method, as known to those skilled in the art. Subsequently, the sampled N+1 dimensional point is mapped to a desired non-flat simplex having simplex vertices xᵢ:

$$X = {[ {x}_{1} , {x}_{2} , … , {x}_{N + 1} ]}_{n ⋆ ( n + 1 )}$$

$$λ = {[ {λ}_{1} , {λ}_{2} , … , {λ}_{N + 1} ]}_{( n + 1 ) ⋆ 1}$$

As a result of the mapping step, the coordinates of a point inside the arbitrary simplex is Y=[y₁, y₂, . . . , y_{N}]=X·λ

By evaluating the corners and DSLM-selected candidate sample points using the KPI values and storing the results in the evaluated points list, the best candidate sample point can be identified on the basis of the KPI values for the evaluated points.

At step 104, the initial or current simplex is split around the best candidate sample point to form a plurality of simplex subspaces. As a result, the initial simplex is partitioned into a plurality of N+1 simplex subspaces.

At step 105, a priority queue is initialized to track the next simplex for splitting as part of an inner loop of processing steps that is repeated for every N+1 iterations, and then the simplex subspaces are stored in the priority queue.

At step 106, the iteration number is incremented (e.g., Iter_Num=Iter_Num+1). The iterative number value enables the number of iterative processing passes of the inner loop to be tracked.

At step 107, the XGBoost model is trained with the points from the “evaluated points” list.

At step 108, the candidate points within each simplex subspace from the priority queue are evaluated based on the inference cost function value using the XGBoost model. For each of the-simplex in the priority queue, the priority of the simplex subspace is determined by computing the inference cost function value with the XGBoost model for each of the Sample_Num candidate points in the simplex subspace, and then the candidate point with the best inferenced cost function value is selected to represent the simplex subspace. Subsequently, the simplex subspace is pushed back to the priority queue with the best inferenced cost function value. The number of simplexes in the priority queue is N+1 for first iteration, and grows with N+1 rate every time a simplex is popped from the priority queue and split and pushed back to create sub-simplexes to the priority queue.

At step 109, the inner loop optima computational path begins by popping or retrieving the simplex subspace from the priority queue which has the best inferenced cost function value.

At step 110 of the inner loop optima computational path, the best candidate point inside the best simplex subspace is evaluated with the real system to generate a corresponding key performance indicator (KPI) output value from the real system, and the resulting candidate point and KPI output value are added to the evaluated points list.

At step 111 of the inner loop optima computational path, the best simplex subspace is split around the best candidate point to form a new set of N+1 simplex subspaces. In addition, a new set of Sample_Num candidate points is selected in each of the new set of N+1 simplex subspaces using DSLM, and the new set of N+1 simplex subspaces is pushed back to the priority queue with minimum priority (e.g., negative infinity) before incrementing the iteration number.

At step 112 of the inner loop optima computational path, the current point value (point.value) is compared to the current optima value (optima.value). If the current point value exceeds the current optima value (affirmative outcome to comparison step 112), then the current optima value is updated with the current point value (step 113). However, if the current point value does not exceed the current optima value (negative outcome to comparison step 112), the method proceeds to determine if the current optimization path computation is finished.

At step 114 of the inner loop optima computational path, it is determined if the current optimization path computation is finished. For example, the current iteration number (Iter_Num) may be compared to the simplex subspace count (N+1) using any suitable comparison tool (e.g., Iter_Num % (N+1)==0). If the current optimization path computation is finished (affirmative outcome to comparison step 114), then the XGBoost model and priority queue values are updated to reflect the results of the completed optimization path computation.

At step 115, a new XGBoost model and priority queue are updated to reflect the results of the optimization path computation. In particular, a new XGBoost model is created with the evaluated points list. In addition, all Sample_Num candidate values for each simplex subspace in the priority queue are updated and any representative values are changed if necessary. In addition, the simplex subspaces are pushed back to the priority queue with new priorities equal to the representative value.

However, if the current optimization path computation is not finished (negative outcome to comparison step 114), then the method determines if the current number of iterations has reached a specified maximum number of iterations in order to determine if another iteration of inner loop optima computational path is performed, or if the current optimization path computation is finished.

At step 116, it is determined if the current number of iterations has reached a specified maximum number of iterations. For example, the current iteration number (Iter_Num) may be compared to a specified maximum number of iterations (N+1)² using any suitable comparison tool (e.g., Iter_Num % (N+1)²==0). If the current number of iterations has not reached a specified maximum number of iterations (negative outcome to comparison step 116), then the method returns to step 109 to retrieve the best simplex subspace from the priority queue, and another iteration of the inner loop optima computational path is performed. However, if the current number of iterations has reached a specified maximum number of iterations (affirmative outcome to comparison step 116), then the current search path is exhausted, and the current optimization path computation is finished.

At step 117, a new optima computation path is initiated by clearing the priority queue and evaluated points list. In addition, the current optima value (optima.value) is added as the initial value in the evaluated points list. In addition, current optima is added to optima vector. In addition, the optima vector is added to the evaluated points list. By adding the optima vector to evaluated points, the information learned from all optimization paths will be used for the next path as prior knowledge. In addition, the next, succeeding prime number is assigned to the Sample_Num value.

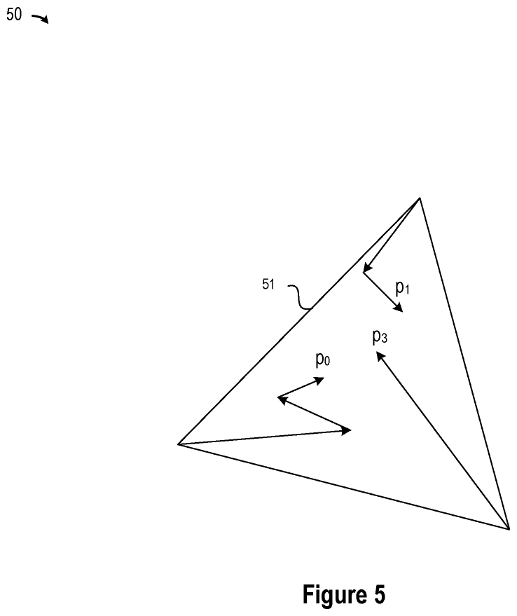

As described here, the Sample_Num value is a prime number so that prime number splitting (PNS) of the simplex prevents collisions between optimization paths (having two spatially dependent points) and suboptimal solutions. This concept is illustrated in FIG. 5 which depicts a simplified illustration showing an N-dimensional simplex space 51 wherein a plurality of optima paths leading to different optima p₀, p₁, p₃ are computed by adding an optima vector to the evaluated points to learn from all optimization paths when selecting a next path. As illustrated, each arrow represents a single iteration for a specific path. Thus, the first path to optima p₀ takes three iterations, while the second path to optima p₁ takes two iterations, and the path to the third optima p₃ takes only one iteration.

To provide additional details for an improved understanding of selected embodiments of the present disclosure, reference is now made to FIG. 6 which depicts a block diagram 60 of an information processing system 200 capable of performing computing operations which uses smart simplex splitting to optimize a plurality of parameters of a non-convex system. As disclosed herein, the parameter optimization functionality may be implemented entirely in selected hardware, entirely in software (including firmware, resident software, micro-code, etc.) or in embodiments combining software and hardware aspects that may all generally be referred to herein as a “circuit,” “module” or “system.” Certain implementations may incorporate all, fewer, or greater than the components described herein.

The depicted information processing system 200 includes a processor unit 202 that is coupled to a system bus 208. Processor unit 202 can have various architectures, such as a system on a chip (SOC), electronic control unit (ECU), general-purpose processor, multiprocessor, custom compute accelerator, FPGA, hard-wired ASIC, etc. A video adapter 210, which controls a display 220, is also coupled to system bus 208. System bus 208 is coupled via a bus bridge 212 to an Input/Output (I/O) bus 214. An I/O interface 218 is coupled to the I/O bus 214 to provide communication with various I/O devices, including one or more input devices 222, a read/write drive 224, and a flash drive memory 226. The format of the ports connected to I/O interface 218 may be any known to those skilled in the art of computer architecture, including but not limited to Universal Serial Bus (USB) ports. The information processing system 200 is able to communicate with external service providers via network interface 216, which is coupled to system bus 208.

A hard drive interface 204 is also coupled as an interface between the hard drive 206 and system bus 208 to populate a system memory 230, which is also coupled to system bus 208. Data that populates system memory 230 includes the operating system (OS) 232 and software programs 240 for the information handling system 200.

The OS 232 includes a shell 234 for providing transparent user access to resources such as software programs 240. Generally, shell 234 is a program that provides an interpreter and an interface between the user and the operating system. More specifically, shell 234 executes commands that are entered into a command line user interface or from a file. Thus, shell 234 (as it is called in UNIX®), also called a command processor in Windows®, is generally the highest level of the operating system software hierarchy and serves as a command interpreter. The shell 234 provides a system prompt, interprets commands entered by keyboard, mouse, or other user input media, and sends the interpreted command(s) to the appropriate lower levels of the operating system (e.g., a kernel 236) for processing. While shell 234 generally is a text-based, line-oriented user interface, the information handling system 200 can also support other user interface modes, such as graphical, voice, gestural, etc. As depicted, OS 232 also includes kernel 236 in which lower levels of functionality for OS 232 are implemented, including essential services required by other parts of OS 232 and software programs 240, including memory management, process and task management, disk management, and mouse and keyboard management.

The software programs 240 may include any number of applications executed by the information handling system 200. In accordance with selected embodiments of the present disclosure, one of the software programs 240 is a system parameter tuning or optimization module 241 which is configured with program code to use a gradient boosting surrogate model 246 for selecting the best simplex subspace to split and for selecting which candidate point inside the selected simplex subspace to evaluate next at the information handling system 200. To this end, the system parameter tuning or optimization module 241 maintains an “evaluated points” list 242 which stores parameter coordinates and corresponding key performance indicator (KPI) value from real system. In addition, the system parameter tuning or optimization module 241 maintains a “priority queue” 243 which tracks which simplex should be split next. In addition, the system parameter tuning or optimization module 241 maintains a “linear simplex splitter” 244 which partitions or splits a simplex using a best candidate sampling point. In addition, the system parameter tuning or optimization module 241 maintains a “Dirichlet Sampling and Linear Mapping Module” 245 which samples a plurality of random, independent candidate sample points inside an arbitrary simplex.

As disclosed herein, the system parameter tuning or optimization module 241 uses the XGBoost surrogate model 246 to determine or estimate cost function values for candidate points identified by the DSLM module 245. In selected embodiments, the XGBoost surrogate model 246 may be wrapped by a MinMax mechanism which ensures sufficient accuracy of the model along the optimization path by increasing the complexity of the XGBoost model as needed to ensure that the absolute error between the real system and XGBoost model are below a specified error threshold.

In addition, the system parameter tuning or optimization module 241 may use prime number splitting with each outer loop optima computation path to ensure that multi-paths toward optima will not collide and to have successive paths learn from preceding paths to find a better path in each iteration. Therefore, the solver will not get stuck in local minima.

By using the XGBoost gradient boosting surrogate model 246 to select the best simplex subspace to split and to selecting which candidate point inside the selected simplex subspace to evaluate next, the system parameter tuning or optimization module 241 does not require an acquisition function which can be difficult to tune for specific applications and which can provide inconclusive or indeterministic results. For example, acquisition functions are needed for Bayesian optimizations which use Gaussian Process as surrogate mode, but Gaussian Processes are not deterministic. In contrast, the XGBoost model is deterministic, so there is no need to define an acquisition function for sampling from the XGBoost model.

Another advantage of the system parameter tuning or optimization module 241 is the use of the DSLM module 245 which promotes intelligent splitting of simplexes by acquiring a set of random, spatially independent points which prevent model immature bias. In particular, the DSLM module 245 is designed for sampling random candidate points from arbitrary subspace simplexes, and the XGBoost surrogate model 246 is used to estimate the cost function for all the candidate points so that the candidate point in each simplex having the best predicted value will be selected to represent each simplex. As a result of the DSLM module 245, the XGBoost surrogate model 246 learns the pure data structure of the cost function when selecting the representative candidate point for splitting, whereas conventional simple (x) methods have a high risk of bias towards middle points of a simplex, causing many optima points to be neglected since they are not in the middle of large simplexes.

The hardware elements depicted in the information processing system 200 are not intended to be exhaustive, but rather are representative to highlight components that can be implemented by the present disclosure. For instance, the information processing system 200 may include alternate memory storage devices. These and other variations are intended to be within the spirit, scope and intent of the present disclosure.

The term “module” may be defined to include a number of executable modules. The modules may include software, hardware or some combination thereof executable by a processor, such as the processor unit 202. Software modules may include instructions stored in memory, such as memory 230, or another memory device, that may be executable by the control processor unit 202 or other processor. Hardware modules may include various devices, components, circuits, gates, circuit boards, and the like that are executable, directed, and/or controlled for performance by the processor unit 202.

A computer readable medium or machine readable medium may include any non-transitory memory device that includes or stores software for use by or in connection with an instruction executable system, apparatus, or device. The machine readable medium may be an electronic, magnetic, optical, electromagnetic, infrared, or semiconductor system, apparatus, or device. Examples may include a portable magnetic or optical disk, a volatile memory such as Random Access Memory “RAM”, a read-only memory “ROM”, or an Erasable Programmable Read-Only Memory “EPROM” or Flash memory. A machine readable memory may also include a non-transitory tangible medium upon which software is stored. The software may be electronically stored as an image or in another format (such as through an optical scan), then compiled, or interpreted or otherwise processed.

As will be appreciated, the term “computer readable medium” may include a single medium or multiple media, such as a centralized or distributed database, and/or associated caches and servers that store one or more sets of instructions. The computer readable medium may also include any medium that is capable of storing, encoding or carrying a set of instructions for execution by a processor or that cause a computer system to perform any one or more of the methods or operations disclosed. The computer readable medium may be non-transitory, and may be tangible. In addition, the computer readable medium may include a solid-state memory, such as a memory card or other package that houses one or more non-volatile read-only memories. The computer readable medium may be a random access memory or other volatile re-writable memory. The computer readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. As will be appreciated, any one or more of a computer readable medium or a distribution medium and other equivalents and successor media may be included for storing data or instructions.

By now it should be appreciated that there has been provided an optimization device, method, program code, and system for optimizing a plurality of parameters in a multi-parameter system. The disclosed optimization device includes a processor which is configured to execute instructions. The disclosed optimization device also includes a memory which is configured to store instructions that, when executed by the processor, cause the processor to optimize a plurality of parameters in a multi-parameter system with an iterative sequence of processing steps. The disclosed optimization steps include searching a multi-parameter simplex search space using a Dirichlet Sampling and Linear Mapping (DSLM) process to identify a specified sampling number of candidate sampling points inside the multi-parameter simplex search space. In selected embodiments, the DSLM process is used to uniformly sample the specified sampling number of candidate sampling points uniformly inside a non-flat arbitrary simplex subspace. The disclosed optimization steps also include applying a surrogate model to identify an optimum non-centered candidate sampling point from the specified sampling number of candidate sampling points inside the multi-parameter simplex search space. In selected embodiments, the surrogate model may be an iteratively trained gradient boosting surrogate model. In other selected embodiments, the surrogate model may be an Extreme Gradient Boosting (XGBoost) model that periodically adjusts a model complexity measure to ensure that a model error measure for all points in an evaluated points list is below a specified maximum error threshold value. In such embodiments, the model complexity measure may be adjusted by increasing a tree count of the XGBoost model if a model error measure for any point in the evaluated points list is above the specified maximum error threshold value. In other selected embodiments, the surrogate model is a machine learning model that is trained to identify the optimum non-centered candidate sampling point. In addition, the disclosed optimization steps include using the optimum non-centered candidate sampling point to split the multi-parameter simplex search space into a plurality of simplex subspaces. In selected embodiments, the disclosed optimization device also includes a priority queue storage device which is used with the surrogate model to track which simplex subspace should be split next. In selected embodiments, the specified sampling number is a prime number that is increased to a consecutive prime number with each iterative sequence of processing steps. In selected embodiments, the instructions are executed to cause the processor to iteratively perform the following steps until an iteration count value equals N: incrementing the iteration count value; generating, for each simplex sub-space, the specified sampling number of candidate sampling points inside each simplex subspace; applying the surrogate model to compute estimated cost function values for the specified sampling number of candidate sampling points inside each simplex subspace; and selecting the optimum non-centered candidate sampling point from the specified sampling number of candidate sampling points inside each simplex subspace which has a maximum or minimum estimated cost function value, where the optimum non-centered candidate sampling point represents a next point to be evaluated for the plurality of parameters in the multi-parameter system.

In another form, there is provided an apparatus, method, program code, and system for optimizing a plurality of parameters in a multi-parameter system. The disclosed system includes at least one computer hardware processor, and also includes at least one non-transitory computer-readable storage medium storing processor-executable instructions that, when executed by the at least one computer hardware processor, cause the at least one computer hardware processor to perform a sequence of operations. In particular, the computer hardware processor initializes an iteration count value and a split or sample count value (Sample_Num).

In selected embodiments, the sample count value (Sample_Num) is a prime number. In addition, the computer hardware processor retrieves an N-dimensional unit simplex covering a multi-parameter search space for the multi-parameter system. The computer hardware processor also identifies a plurality of Sample_Num spatially independent, randomized candidate sampling points inside the N-dimensional unit simplex. In selected embodiments, the a Dirichlet Sampling and Linear Mapping (DSLM) process is used to identify the plurality of Sample_Num spatially independent, randomized candidate sampling points inside the N-dimensional unit simplex. In addition, the computer hardware processor applies a gradient boosting surrogate model to compute an estimated cost function value for each of the plurality of Sample_Num spatially independent, randomized candidate sampling points. In selected embodiments, the gradient boosting surrogate model is an Extreme Gradient Boosting (XGBoost) model. The computer hardware processor also selects a first sampling point from the plurality of Sample_Num spatially independent, randomized candidate sampling points which has a maximum or minimum estimated cost function value, where the first sampling point represents a first optima value for the plurality of parameters in the multi-parameter system. In selected embodiments, the first sampling point is a set of hyper-parameter values of a non-convex system having a first estimated cost function value that is computed with the gradient boosting surrogate model. In addition, the computer hardware processor partitions the N-dimensional unit simplex around the first sampling point to form N+1 simplex sub-spaces. The computer hardware processor also updates an evaluated points list with the plurality of Sample_Num spatially independent, randomized candidate sampling points and corresponding estimated cost function values. In addition, the computer hardware processor trains the gradient boosting surrogate model with the evaluated points list. In selected embodiments, the processor-executable instructions also cause the at least one computer hardware processor to iteratively perform a sequence of steps until an adequate solution is obtained, where the sequence of steps includes incrementing the iteration count value; generating, for each of the N+1 simplex sub-spaces, a plurality of Sample_Num spatially independent, randomized candidate sampling points inside each of simplex subspace; applying the gradient boosting surrogate model to compute estimated cost function values for the plurality of Sample_Num spatially independent, randomized candidate sampling points inside each simplex subspace; and selecting a subspace sampling point from the plurality of Sample_Num spatially independent, randomized candidate sampling points inside each simplex subspace which has a maximum or minimum estimated cost function value, where the subspace sampling point represents a next point to be evaluated for the plurality of parameters in the multi-parameter system. As will be appreciated, the sequence of steps may be iteratively repeated until an adequate solution is obtained, such as when the optima. value exceeds a predetermined threshold. In selected embodiments, the gradient boosting surrogate model is an Extreme Gradient Boosting (XGBoost) model that periodically adjusts a model complexity measure to ensure that a model error measure for all points in the evaluated points list is below a specified maximum error threshold value. In such embodiments, the model complexity measure may be adjusted by increasing a tree count of the XGBoost model if a model error measure for any point in the evaluated points list is above the specified maximum error threshold value. In selected embodiments, the processor-executable instructions may also cause the at least one computer hardware processor to re-initialize the iterative iteration count value and set the sample count value (Sample_Num) to a different or consecutive prime number value before performing a second sequence of processing steps, including retrieving the N-dimensional unit simplex covering the multi-parameter search space for the multi-parameter system; identifying a second plurality of Sample_Num spatially independent, randomized candidate sampling points inside the N-dimensional unit simplex; applying the gradient boosting surrogate model to compute estimated cost function values for the second plurality of Sample_Num spatially independent, randomized candidate sampling points; selecting a new sampling point from the second plurality of Sample_Num spatially independent, randomized candidate sampling points which has a maximum or minimum estimated cost function value, where the new sampling point represents a next point to be evaluated for the plurality of parameters in the multi-parameter system; partitioning the N-dimensional unit simplex around the new sampling point to form N+1 simplex sub-spaces; updating the evaluated points list with the new sampling point; and training the gradient boosting surrogate model with the updated evaluated points list.

In yet another form, there is provided an apparatus, method, program code, and system for tuning a plurality of parameters in a multi-parameter system. In the disclosed method, a first step (a) retrieves an N-dimensional non-flat arbitrary simplex covering a multi-parameter search space for the multi-parameter system. In addition, a subsequent step (b) identifies a plurality of spatially independent, randomized candidate sampling points inside the N-dimensional non-flat arbitrary simplex by applying a Dirichlet Sampling and Linear Mapping

(DSLM) process to the N-dimensional non-flat arbitrary simplex. In addition, a subsequent step (c) applies an Extreme Gradient Boosting (XGBoost) surrogate model to compute an estimated cost function value for each of the plurality of spatially independent, randomized candidate sampling points. In addition, a subsequent step (d) selects an optimum non-centered candidate sampling point from the plurality of spatially independent, randomized candidate sampling points in the N-dimensional non-flat arbitrary simplex, where the optimum non-centered candidate sampling point has a maximum or minimum estimated cost function value and represents a first optima value for the plurality of parameters in the multi-parameter system. In addition, a subsequent step (e) partitions the N-dimensional non-flat arbitrary simplex around the optimum non-centered candidate sampling point to form N+1 non-flat arbitrary simplex subspaces. In addition, a subsequent step (f) updates an evaluated points list with the optimum non-centered candidate sampling point. In addition, a subsequent step (g) trains the XGBoost surrogate model with the evaluated points list. In selected embodiments, the plurality of spatially independent, randomized candidate sampling points are identified by identifying a first prime number of spatially independent, randomized candidate sampling points inside the N-dimensional non-flat arbitrary simplex during a first iterative pass of steps (a)-(g), and then identifying a second, consecutive prime number of spatially independent, randomized candidate sampling points inside the N-dimensional non-flat arbitrary simplex during a second iterative pass of steps (a)-(g).

Although the described exemplary embodiments disclosed herein focus on a computer-based method, system, architecture, apparatus, and program code for optimizing parameters of a system by using a gradient boosting surrogate model to select the best simplex subspace to split and to select which candidate point inside the selected simplex subspace to evaluate next, the present invention is not necessarily limited to the example embodiments illustrate herein and may be applied to any parameter tuning or optimization system. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An optimization device, comprising:
a processor which is configured to execute instructions; and
a memory which is configured to store instructions that, when executed by the processor, cause the processor to optimize a plurality of parameters in a multi-parameter system with an iterative sequence of processing steps for:
searching a multi-parameter simplex search space using a Dirichlet Sampling and Linear Mapping (DSLM) process to identify a specified sampling number of candidate sampling points inside the multi-parameter simplex search space,
applying a surrogate model to identify an optimum non-centered candidate sampling point from the specified sampling number of candidate sampling points inside the multi-parameter simplex search space;
using the optimum non-centered candidate sampling point to split the multi-parameter simplex search space into a plurality of simplex subspaces.

2. The optimization device of claim 1, where the surrogate model is an iteratively trained gradient boosting surrogate model.

3. The optimization device of claim 1, further comprising a priority queue storage device which is used with the surrogate model to track which simplex subspace should be split next.

4. The optimization device of claim 1, where the specified sampling number is a prime number that is increased to a consecutive prime number with each iterative sequence of processing steps.

5. The optimization device of claim 1, where the surrogate model comprises a machine learning model that is trained to identify the optimum non-centered candidate sampling point.

6. The optimization device of claim 1, where the DSLM process is used to uniformly sample the specified sampling number of candidate sampling points uniformly inside a non-flat arbitrary simplex subspace.

7. The optimization device of claim 1, wherein the instructions, when executed by the processor, cause the processor to iteratively perform the following steps until an iteration count value equals N:
incrementing the iteration count value;
generating, for each of simplex sub-space, the specified sampling number of candidate sampling points inside each simplex subspace;
applying the surrogate model to compute estimated cost function values for the specified sampling number of candidate sampling points inside each simplex subspace; and
selecting the optimum non-centered candidate sampling point from the specified sampling number of candidate sampling points inside each of simplex subspace which has a maximum or minimum estimated cost function value, where the optimum non-centered candidate sampling point represents a next point to be evaluated for the plurality of parameters in the multi-parameter system.

8. The optimization device of claim 1, wherein the surrogate model is an Extreme Gradient Boosting (XGBoost) model that periodically adjusts a model complexity measure to ensure that a model error measure for all points in an evaluated points list is below a specified maximum error threshold value.

9. The optimization device of claim 8, wherein the model complexity measure is adjusted by increasing a tree count of the XGBoost model if a model error measure for any point in the evaluated points list is above the specified maximum error threshold value.

10. A system for optimizing a plurality of parameters in a multi-parameter system, comprising:
at least one computer hardware processor; and
at least one non-transitory computer-readable storage medium storing processor-executable instructions that, when executed by the at least one computer hardware processor, cause the at least one computer hardware processor to perform:
initializing an iteration count value and a sample count value (Sample_Num);
retrieving an N-dimensional unit simplex covering a multi-parameter search space for the multi-parameter system;
identifying a plurality of Sample_Num spatially independent, randomized candidate sampling points inside the N-dimensional unit simplex;
applying a gradient boosting surrogate model to compute an estimated cost function value for each of the plurality of Sample_Num spatially independent, randomized candidate sampling points;
selecting a first sampling point from the plurality of Sample_Num spatially independent, randomized candidate sampling points which has a maximum or minimum estimated cost function value, where the first sampling point represents a first optima value for the plurality of parameters in the multi-parameter system;
partitioning the N-dimensional unit simplex around the first sampling point to form N+1 simplex sub-spaces;
updating an evaluated points list with the first sampling point; and
training the gradient boosting surrogate model with the evaluated points list.

11. The system of claim 10, where the sample count value (Sample_Num) is a prime number.

12. The system of claim 10, where a Dirichlet Sampling and Linear Mapping (DSLM) process is used to identify the plurality of Sample_Num spatially independent, randomized candidate sampling points inside the N-dimensional unit simplex.

13. The system of claim 10, where the gradient boosting surrogate model is an Extreme Gradient Boosting (XGBoost) model.

14. The system of claim 10, wherein the processor-executable instructions further cause the at least one computer hardware processor to iteratively perform the following steps until the iteration count value equals N:
incrementing the iteration count value;
generating, for each of the simplex sub-spaces, a plurality of Sample_Num spatially independent, randomized candidate sampling points inside each of simplex subspaces;
applying the gradient boosting surrogate model to compute estimated cost function values for the plurality of Sample_Num spatially independent, randomized candidate sampling points inside each simplex subspace; and
selecting a subspace sampling point from the plurality of Sample_Num spatially independent, randomized candidate sampling points inside each simplex subspace which has a maximum or minimum estimated cost function value, where the subspace sampling point represents a next point to be evaluated for the plurality of parameters in the multi-parameter system.

15. The system of claim 10, wherein the gradient boosting surrogate model is an Extreme Gradient Boosting (XGBoost) model that periodically adjusts a model complexity measure to ensure that a model error measure for all points in the evaluated points list is below a specified maximum error threshold value.

16. The system of claim 15, wherein the model complexity measure is adjusted by increasing a tree count of the XGBoost model if a model error measure for any point in the evaluated points list is above the specified maximum error threshold value.

17. The system of claim 10, wherein the first sampling point is a set of hyper-parameter values of a non-convex system having a first estimated cost function value that is computed with the gradient boosting surrogate model.

18. The system of claim 10, wherein the processor-executable instructions further cause the at least one computer hardware processor to re-initialize the iterative iteration count value and set the sample count value (Sample_Num) to a consecutive prime number value before:
retrieving the N-dimensional unit simplex covering the multi-parameter search space for the multi-parameter system;
identifying a second plurality of Sample_Num spatially independent, randomized candidate sampling points inside the N-dimensional unit simplex;
applying the gradient boosting surrogate model to compute estimated cost function values for the second plurality of Sample_Num spatially independent, randomized candidate sampling points;
selecting a new sampling point from the second plurality of Sample_Num spatially independent, randomized candidate sampling points which has a maximum or minimum estimated cost function value, where the new sampling point represents a second point to be evaluated for the plurality of parameters in the multi-parameter system;
partitioning the N-dimensional unit simplex around the new sampling point to form N+1 simplex sub-spaces;
updating the evaluated points list with the new sampling point; and
training the gradient boosting surrogate model with the updated evaluated points list.

19. A method for tuning a plurality of parameters in a multi-parameter system, comprising:
(a) retrieving an N-dimensional non-flat arbitrary simplex covering a multi-parameter search space for the multi-parameter system;
(b) identify a plurality of spatially independent, randomized candidate sampling points inside the N-dimensional non-flat arbitrary simplex by applying a Dirichlet Sampling and Linear Mapping (DSLM) process to the N-dimensional non-flat arbitrary simplex;
(c) applying an Extreme Gradient Boosting (XGBoost) surrogate model to compute an estimated cost function value for each of the plurality of spatially independent, randomized candidate sampling points;
(d) selecting an optimum non-centered candidate sampling point from the plurality of spatially independent, randomized candidate sampling points in the N-dimensional non-flat arbitrary simplex, where the optimum non-centered candidate sampling point has a maximum or minimum estimated cost function value and represents a first optima value for the plurality of parameters in the multi-parameter system;
(e) partitioning the N-dimensional non-flat arbitrary simplex around the optimum non-centered candidate sampling point to form N+1 non-flat arbitrary simplex subspaces;
(f) updating an evaluated points list with the optimum non-centered candidate sampling point; and
(g) training the XGBoost surrogate model with the evaluated points list.

20. The method of claim 19, where identifying the plurality of spatially independent, randomized candidate sampling points comprises:
identifying a first prime number of spatially independent, randomized candidate sampling points inside the N-dimensional non-flat arbitrary simplex during a first iterative pass of steps (a)-(g), and
identifying a second, consecutive prime number of spatially independent, randomized candidate sampling points inside the N-dimensional non-flat arbitrary simplex during a second iterative pass of steps (a)-(g).
